(19) United States
(12) Patent Application Publication
(10) Pub. No.: US 2023/0068412 A1
(43) Pub. Date: Mar. 2, 2023

(54) AD HOC GROUP BASED SERVICES TO SUPPORT 5G SYSTEM (5GS) SCENARIOS

(71) Applicant: NOKIA TECHNOLOGIES OY, Espoo (FI)

(72) Inventors: Shubhranshu SINGH, Seeheim-Jugenheim (DE); Laurent THIEBAUT, Antony (FR); Devaki CHANDRAMOULI, Plano, TX (US); Swaminathan ARUNACHALAM, Allen, TX (US); Lazaros GKATZIKIS, Issy-les-Moulineaux (FR)

(21) Appl. No.: 17/888,789

(22) Filed: Aug. 16, 2022

Related U.S. Application Data
(60) Provisional application No. 63/233,497, filed on Aug. 16, 2021.

(51) Int. Cl. H04W 4/08

(52) U.S. Cl. CPC H04W 4/08; H04W 84/18

(57) ABSTRACT

Systems, methods, apparatuses, and computer program products for ad hoc group based services to support 5G system (5GS) scenarios such as, but not limited to, edge computing and time synchronization, are provided.

### CROSS REFERENCE TO RELATED APPLICATION

This application claims the benefit of U.S. Provisional Application No. 63/233,497, filed Aug. 16, 2021. The entire content of the above-referenced application is hereby incorporated by reference.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for ad hoc group based service to support 5G system (5GS) scenarios such as, but not limited to, edge computing and time synchronization.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to a method, which may include determining, by a network node, to dynamically configure an ad hoc group of user equipment within a 5G system. The ad hoc group of user equipment comprises dynamic group members. The method may also include creating the ad hoc group of user equipment. The creating comprises assigning group information for the ad hoc group, and the group information comprises at least an external ad hoc group identifier.

An embodiment may be directed to an apparatus including at least one processor and at least one memory comprising computer program code. The at least one memory and computer program code configured, with the at least one processor, to cause the apparatus at least to perform: determining to dynamically configure an ad hoc group of user equipment within a 5G system. The ad hoc group of user equipment comprises dynamic group members. The apparatus may also be caused to perform: creating the ad hoc group of user equipment. The creating comprises assigning group information for the ad hoc group, and the group information comprises at least an external ad hoc group identifier.

An embodiment may be directed to an apparatus including means for determining to dynamically configure an ad hoc group of user equipment within a 5G system. The ad hoc group of user equipment comprises dynamic group members. The apparatus may also include means for creating the ad hoc group of user equipment. The means for creating comprises means for assigning group information for the ad hoc group, and the group information comprises at least an external ad hoc group identifier.

In an embodiment, the method may include, or the apparatus caused to perform, sending, to a user data storage entity, a request comprising the group information for storage in the Unified Data Repository storage entity.

In an embodiment, the group information may further comprise at least one of: a group type; a list of the member user equipment in the ad hoc group; property or an application or use case related with the group membership definition; an indication of one or more user equipment in a pre-defined or subscribed group that can be part of the ad hoc group; or a lifetime, time period or duration for the ad hoc group.

In an embodiment, the property related with the group membership definition comprises at least one of: a tracking area, cell identifier, location coordinates for the user equipment in the ad hoc group; an indication of user equipment having joined a certain multicast content; an indication of time synchronization service area for a given time domain serving area; an indication of the user equipment served by the same entity with a specific application running; an indication of a user plane node serving the user equipment in the ad hoc group; or an indication of device, application or use case category for the user equipment to be present in the ad-hoc group.

In an embodiment, the determining may include determining to configure the ad hoc group of user equipment for a specific use case or application.

In an embodiment, the method may include, or the apparatus caused to perform, dynamically updating or deleting the group information when a change to the ad hoc group occurs.

In an embodiment, the method may include, or the apparatus caused to perform, receiving, from an application function, a request to subscribe to notifications specific to the ad hoc group, wherein the request identifies the ad hoc group by the ad hoc group identifier.

In an embodiment, the network node or the apparatus may comprise at least one of a network function, or a 5G core network node.

An embodiment may be directed to a method that may include receiving, at a unified data management entity or unified data repository, a request comprising group information for an ad hoc group of user equipment. The group information may include at least an external ad hoc group identifier. The method may also include storing the group information for the ad hoc group of user equipment.

An embodiment may be directed to an apparatus including at least one processor and at least one memory comprising computer program code. The at least one memory and computer program code configured, with the at least one processor, to cause the apparatus at least to perform: receiving a request comprising group information for an ad hoc group of user equipment. The group information may include at least an external ad hoc group identifier. The apparatus may also be caused to perform: storing the group information for the ad hoc group of user equipment.

An embodiment may be directed to an apparatus including means for receiving a request comprising group information for an ad hoc group of user equipment. The group information may include at least an external ad hoc group identifier. The apparatus may also include means for storing the group information for the ad hoc group of user equipment.

In an embodiment, the group information may further include at least one of: a group type; a list of the member user equipment in the ad hoc group; property related with the group membership definition; an indication of one or more user equipment in a pre-defined or subscribed group that can be part of the ad hoc group; or a lifetime, time period or duration for the ad hoc group.

In an embodiment, the storing may include storing at least one of the group type or a sub-group type to differentiate between an ad hoc group of user equipment and a static or permanent group of user equipment.

In an embodiment, the method may include, or the apparatus may be caused to perform, mapping the ad hoc group into an internal 5G System group.

In an embodiment, the property related with the group membership definition comprises at least one of: a tracking area, cell identifier, location coordinates for the user equipment in the ad hoc group; an indication of user equipment having joined a certain multicast content; an indication of time synchronization service area for a given time domain serving area; an indication of the user equipment served by the same entity with a specific application running; or an indication of a user plane node serving the user equipment in the ad hoc group.

In an embodiment, the storing may include storing at least one of: a sub-group type for the ad hoc group, or rules for membership to the ad hoc group.

In an embodiment, the method may include, or the apparatus may be caused to perform, receiving an update of the group information when a change to the ad hoc group occurs.

In an embodiment, the method may include, or the apparatus may be caused to perform, receiving, from a consumer network node, a subscription to receive notifications for updates or changes to the ad hoc group, and notifying the subscribing consumer network node when the updates or changes occur in the ad hoc group.

An embodiment may be directed to a method that may include receiving, at a 5G core network node, a request comprising group information for an ad hoc group of user equipment. The group information may include at least an external ad hoc group identifier. The method may also include transforming the external ad hoc group identifier into a 5G core ad-hoc group identifier that is unique within the 5G System.

An embodiment may be directed to an apparatus including at least one processor and at least one memory comprising computer program code. The at least one memory and computer program code configured, with the at least one processor, to cause the apparatus at least to perform: receiving a request comprising group information for an ad hoc group of user equipment. The group information may include at least an external ad hoc group identifier. The apparatus may also be caused to perform: transforming the external ad hoc group identifier into a 5G core ad-hoc group identifier that is unique within the 5G System.

An embodiment may be directed to an apparatus including means for receiving a request comprising group information for an ad hoc group of user equipment. The group information may include at least an external ad hoc group identifier. The apparatus may also include means for transforming the external ad hoc group identifier into a 5G core ad-hoc group identifier that is unique within the 5G System.

### BRIEF DESCRIPTION OF THE DRAWINGS

For proper understanding of example embodiments, reference should be made to the accompanying drawings, wherein:

FIG. 1 illustrates an example signaling diagram, according to an embodiment;

FIG. 2 illustrates an example signaling diagram, according to an embodiment;

FIG. 3 illustrates an example signaling diagram, according to an embodiment;

FIG. 4 illustrates an example flow chart of a method, according to an embodiment;

FIG. 5 illustrates an example flow chart of a method, according to an embodiment;

FIG. 6 illustrates an example flow chart of a method, according to an embodiment;

FIG. 7A illustrates an example block diagram of an apparatus, according to an embodiment;

FIG. 7B illustrates an example block diagram of an apparatus, according to an embodiment; and

FIG. 7C illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for ad hoc group based service to support 5G system (5GS) scenarios such as, but not limited to, edge computing and time synchronization, is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Application functions (AF) can provide traffic influence information to 5^{th} generation core network (5GC) in which the AF may indicate a particular UE, a group of UEs or any UE. However, this UE group refers to a well-defined and static subscription-based group. For example, the group of UEs can be identified by an external group identifier when the AF interacts via a network exposure function (NEF) or an internal group identifier when the AF interacts directly with a policy control function (PCF) (e.g., see 3GPP TS 23.501 and 23.682).

When an AF request targets any UE or a group of UE, the AF request is likely to influence multiple protocol data unit (PDU) sessions possibly served by multiple session management functions (SMFs) and PCFs. When the AF request targets a group of UEs, it provides one or several group identifiers in its request. The group identifiers provided by the AF are mapped to internal group identifiers. Members of the group have this group identifier in their subscription. The internal group Identifier is stored in unified data management (UDM), retrieved by SMF from UDM and passed by SMF to PCF at PDU session set-up. The PCF can then map the AF requests with user subscription and determine whether an AF request targeting a group of users applies to a PDU Session.

Certain deployments and use cases, such as time sensitive network (TSN), platooning and multi-user gaming may require supporting the dynamic creation and management of a collection of UEs handled collectively. Some of these deployments have a need for the dynamic management of the multiple UEs' application-clients that are registered to a particular edge application server (EAS) or gaming server with specific user ID and/or app ID, etc. Due to UE mobility, server load balancing, maintenance and so on, there may be a need for simultaneous offloading of a specific collection of UEs to local EAS/AF, for the dynamic provision of member UEs info to the 5GC as well as to edge hosting environment, and for PDU session anchor (PSA)-user plane function (UPF) relocation for the collection of UEs.

Problems arise in determining how to allow an AF and 5GC to form and dynamically update an ad-hoc or dynamic group based on criteria, such as: all UEs anchored at the same PSA-UPF, or all UEs running applications on same EAS (e.g., registered with respective application user-ID to same EAS for a particular App-ID). In addition, there is a need for determining how to enable all UEs (belonging to the same ad-hoc/dynamic group) to be relocated simultaneously to another EAS, and/or determining how to enable all UEs on PSA-UPF-1 be relocated to PSA-UPF-2, if they belong to the same Ad-Hoc group. Further, it may need to be determined how to create a time synchronization group and ensure that all group members are served by the same PTP instance.

For time synchronization, a SMF exposes the network side TSN translator (NW-TT) serving the UE. AF obtains the list of UE(s) being served by a given NW-TT, creates a group for precision time protocol (PTP) time synchronization activation requests based on the UPF that is serving the UE. NEF exposes the NW-TT serving the UE, and AF creates the time synchronization group ensuring that they are served by the same NW-TT thus also the same (g)PTP time instances. However, this approach has at least the drawback that it restricts the time synchronization group to the UE(s) served by the same UPF/NW-TT only, N19 is not considered, whereas UE-UE communication and UE-UE time-synchronization could also be supported using N19 (i.e., UE-1 served by UPF/NW-TT-1 and UE-2 served by UPF/NW-TT-2). Example embodiments discussed herein can overcome at least this drawback, as well as other problems whether explicitly discussed herein or not.

Therefore, certain example embodiments discussed herein provide for the creation of ad-hoc groups, which are a dynamically created group of UEs that is used for a specific purpose, service and duration. This ad hoc group of UEs may be created as a subset of the static subscription groups to be in compliance with the operator policy.

In an embodiment, when a NF creates such an ad-hoc group, it may provide e.g. to the AF, an explicit list of group members that may be identified by the UE ID or UE address. Additionally or alternatively, the NF may provide an implicit list of group members where group members correspond to any UE that shares a specific property related with the group membership definition.

Example embodiments introduce certain procedures to support the configuration and creation of ad hoc UE groups. According to one embodiment, an AF may be configured to create an ad-hoc group and provide, to the 5GC, group information relating to the created ad-hoc group. For example, the group information may include an external ad-hoc group-ID. In an embodiment, the 5GC may transform the external ad-hoc group-ID (group as identified by the NF that has created the group) into a 5GC ad-hoc group-ID that is unique within the 5GC. Optionally, the group information provided to the 5GC may include a list of member UEs (identified by the UE ID or UE address), or property related with the group membership definition. According to certain embodiments, the AF provides just one of the list of member UEs or the property related with the group membership definition to the 5GC. In an embodiment, the property related with the group membership definition may include: (i) tracking area, cell ID, location coordinates, e.g., the UEs within TAI-1, TAI-2, etc., (ii) the UE(s) having joined a multicast content, (iii) time synchronization service area for a given time domain (PTP per IEEE 1588) serving area, (iv) the UEs served by the same entity, e.g., on a particular EAS with a specific application running, and/or (v) UPF serving the UE, e.g., group defined based on UE being served by the same PSA-UPF. Further, in some embodiments, the group information provided to the 5GC may optionally include a pre-defined or subscribed group. In this case, just the UE members of this pre-defined/subscribed group may be part of the ad-hoc group such that the ad-hoc group is a subset of the pre-defined/subscribed group. Additionally, in one embodiment, the group information provided to the 5GC may optionally include a group lifetime and/or duration.

In some embodiments, a single UE may be part of multiple ad-hoc groups. For example, a UE can be a member of group-A for multi-user gaming, group-B for time synchronization, and group-C for vehicle-to-everything (V2X)/platoon.

According to certain embodiments, when a NF (e.g., an AF) creates a group providing the explicit list of member UEs, this list may have been built using one of the criteria above but this is then transparent to the 5GC.

In one embodiment, the ad-hoc group information may be configured or provided to a UDM. For instance, the AF may configure the UDM via a NEF with the dynamically formed ad-hoc groups. Updates to NEF API may be performed, for example, via Nnef_ParameterProvision_Create/Update service operation or new API, e.g., Nnef_groupprovision_Create/update/delete. The NEF may perform AF request authorization and provide necessary mappings. The mappings may be based on user ID (e.g., GPSI), UE ID (if provided), DNN, or S-NSSAI. The AF may contact the UDM for setting and/or updating the ad-hoc group information. The UDM can map this ad hoc group into 5GC internal group, indicating it is an “ad-hoc” group and may store ad-hoc group information with additional characteristics, such as group type indication to differentiate between ad-hoc group and subscribed group or sub-group type, if any. The AF may also indicate that the ad-hoc group is created for a specific period of time (i.e. this could be based on subscription, time period when the ad-hoc period makes sense e.g. friends playing a game and for the duration of the game).

According to certain embodiments, the UDM may store this ad-hoc group content in UDR. The group membership information may be provided to consumer network function. If the group membership information is to be provided to the AMF and/or to SMF, the following two mechanisms may be applied. When a property related with the group membership definition has been provided: NF (e.g., AMF, SMF) interested in knowing these ad-hoc groups may subscribe to UDR about changes (creation/modification/deletion) of such groups. When such groups are subject to a creation/modification/deletion, the UDR notifies the subscribed NF. The subscribed NF (e.g., AMF, SMF) may check whether the property related with the group membership definition applies for the UE(s) and/or PDU session they handle. For ad-hoc groups whose membership is explicitly defined, the UDM may, when sending subscription data to AMF and SMF, check whether the target UE is belonging to an ad-hoc group.

According to certain embodiments, the UE group members list may be dynamically updated to support group member change. For insance, Nnef_ParameterProvision_Update or a new service operation, e.g., Nnef_groupprovision_update operation (from AF to the 5GC) can be used by the AF to provide updates to the group. Additionally or alternatively, the SMF may dynamically update other NFs, for example, via enhancements to Nsmf_EventExposure_Notify operation and/or other services defined for such purposes.

Example embodiments may be configured to expose time sync service area and/or PTP service area for a given time domain from NEF to AF. The AF can create the ad hoc group for time sync service activation based on the serving area. Further, certain embodiments provide dynamic group management capabilities in the NEF that can be used for time sync PTP groups, ensuring that the UE(s) are in the same serving area for PTP instance. This way, the AF can group and request time sync for a group of UE(s) (e.g., UE1/UE2/UE3) corresponding to a given PTP instance, thereby avoiding the dependency to UE(s) served by a single NW-TT and thus also supporting UE(s) spanning across UPFs/N19.

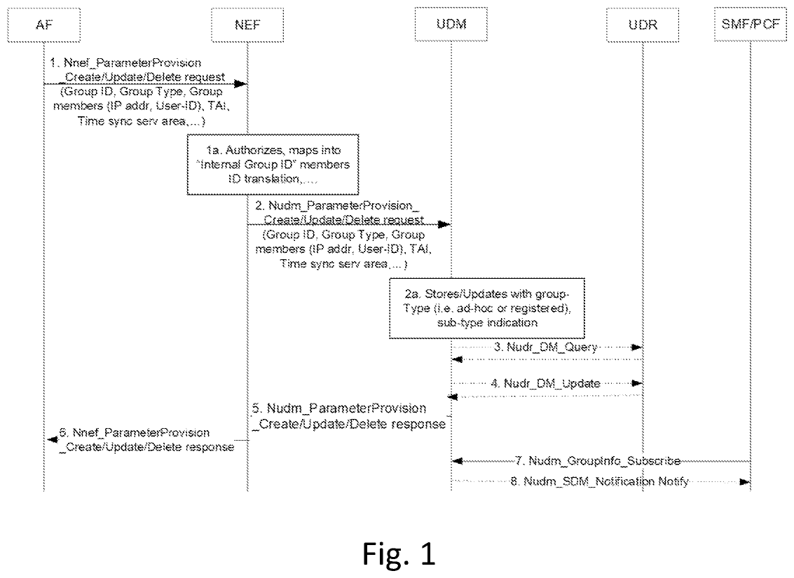

FIG. 1 illustrates an example signaling diagram depicting the creating or forming of an ad hoc UE group by AF, according to one embodiment. The signaling diagram in the example of FIG. 1 depicts messages transmitted and received between an AF, NEF, UDM, UDR and SMF/PCF. The AF may have the capability to configure an ad hoc group of user equipment dynamically and influence ad hoc group creation with the 5GS. In the example of FIG. 1, an AF may create and configure an ad-hoc group of UEs including dynamic group members, and may subsequently provide the group profiles for storage in the UDM. A consumer network function, such as SMF or PCF, can then retrieve such ad hoc group details from the UDM, as required. The ad hoc group members and profiles can be dynamically updated by the AF, such as when a certain UE is no longer registered on a particular application server, etc.

In particular, as illustrated in the example of FIG. 1, the AF may decide to configure an ad-hoc group of UEs. This decision to configure an ad hoc group of UEs may be for one or more specific use cases or applications, and/or may be based on different group information or criteria, as introduced above. For instance, in an embodiment, the group information for the configured ad hoc group may include an assigned external ad hoc group ID. Optionally, the group information may include a list of member UEs of the ad hoc group, e.g., identified by the UE ID or UE address, or a class of UE(s) mapped to a certain use case or a specific property related with the group membership definition. In an embodiment, the property related with the group membership definition may include: (i) tracking area, cell ID, location coordinates, e.g., the UEs within TAI-1, TAI-2, etc., (ii) the UE(s) having joined a multicast content, (iii) time synchronization service area for a given time domain serving area, (iv) the UEs served by the same entity, e.g., on an EAS-1 with a specific application running, (v) UPF serving the UE, e.g., where the group is defined based on UE being served by the same PSA-UPF and/or (vi) class of UE(s) determined by a use case (e.g. CIoT UE(s), Public safety UE(s)). Further, in some embodiments, the group information may optionally include a pre-defined or subscribed group. In this case, the ad hoc group includes UE members of this pre-defined/subscribed group, i.e., such that the ad-hoc group is a subset of the pre-defined/subscribed group. Additionally, in one embodiment, the group information may optionally include a group lifetime and/or duration.

In the example of FIG. 1, the AF may assign a group ID, group type and may include a list of UE group members. As illustrated in the example of FIG. 1, at 1, the AF may then send a Nnef_ParameterProvision_Create/Update/Delete request, e.g., including the group ID, group type, group members (e.g., identified by IP address, User-ID), TAI, time sync service area, and/or EAS ID, etc. to the UDM (e.g., via the NEF in case of non-trusted AF deployment). Alternatively, the AF may use newly defined API for this purpose, e.g., Nnef_groupprovision_Create/update/delete to provision the group information to the UDM. In one example, the group type may indicate that the created (or updated) group is a dynamic or ad hoc group, rather than a static or permanent group.

In the example of FIG. 1, at 1a, the NEF may authorize the AF request and map the received ad hoc group ID to an internal group ID. At 2, after authorizing the AF request, the NEF may create or updates the group information in the UDM, e.g., by sending a Nudm_ParameterProvision_Create/Update/Delete request including one or more of the group ID, group type, group members (IP address, User-ID), TAI, Time sync service area, EAS ID, etc.

As further illustrated in the example of FIG. 1, at 2a, UDM/UDR may store or update the received ad-hoc group information or details. For example, the UDM may store the group type, e.g., in order to differentiate such temporary ad-hoc groups from those permanent/static groups based on user subscriptions. The UDM may also have a sub-group type indication. Further, in an embodiment, rules for ad-hoc membership may also be stored in the UDR. The rules may be provisioned by the AF, e.g., using enhancements to Nnef_ParameterProvision API.

According to an embodiment, as shown at 3 and 4 of FIG. 1, group related information may be communicated and/or stored in the UDR using Nudr_DM_Query/Update messages. As illustrated at 5 and 6 of FIG. 1, the AF may receive a response message to the request it sent at 1. As depicted in FIGS. 1 at 7 and 8, a consumer network function, such as a SMF or PCF, may subscribe and be notified of the group information stored at the UDM/UDR.

In some embodiments, in case of PCF-AM subscription for ad-hoc membership in the UDR, when an AM policy association has been established and during the lifetime of the association, the PCF may check whether a rule for ad-hoc membership is applicable to the UE. When an ad-hoc group is no longer applicable to the UE, the PCF may request the UDM to update the user subscription with new membership information (e.g., UE member of a new group, UE is no longer a member of a group).

It is noted that FIG. 1 is provided as one example embodiment. However, certain embodiments are not limited to this example, and further examples are possible as discussed elsewhere herein.

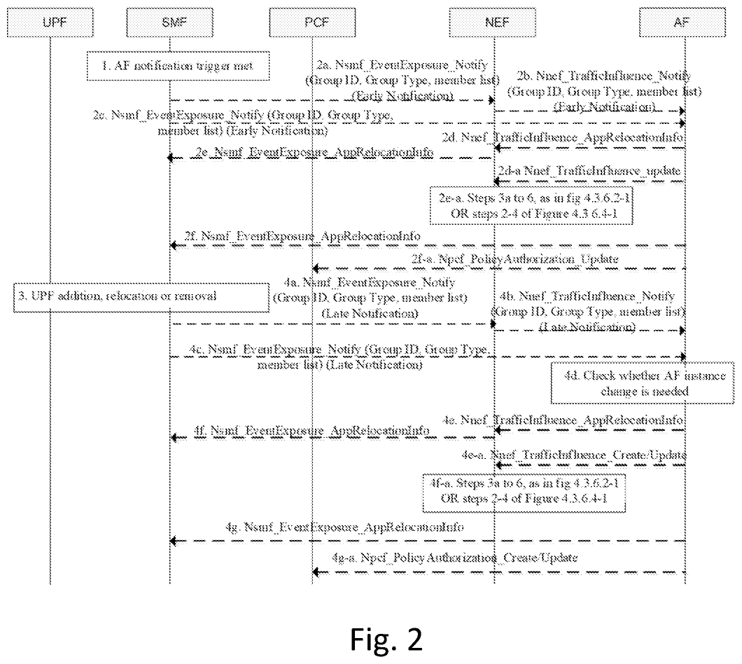

FIG. 2 illustrates an example signaling diagram depicting ad hoc group configuration and updates initiated by 5GC, according to one embodiment. The signaling diagram in the example of FIG. 2 depicts messages transmitted and received between an UPF, SMF, PCF, NEF, and an AF. In the example of FIG. 2, a 5GC node, such as a SMF, may be configured to initiate ad hoc group creation, configuration, group member updates, etc. Additionally, with the group information, e.g., including ad-hoc group ID, member list, etc. from a UDR, the SMF may also report any updates to the group, such as adding or removing certain UE(s) from the group (e.g. due to PSA-UPF change of a particular UE, and the like) and/or (vi) class of UE(s) determined by a use case (e.g. CIoT UE(s), Public safety UE(s)).

As illustrated in the example of FIG. 2, at 1, the SMF may decide to configure an ad hoc group of UEs. The decision to configured the ad hoc UE group may be for specific use case(s) or application(s) and can be based on different criteria including those discussed above, for example, based on a time sync service area for a given time domain, PTP serving area, UPF serving the UE, e.g., based on UE on same PSA-UPF, etc. At 2a and 2b, the SMF may then notify the AF by sending Nsmf EventExposure Notify (e.g., including group ID, member list, etc.) (Early Notification) and Nnef_TrafficInfluence_Notify (e.g., including the group ID, member list) (Early Notification) via the NEF, or by sending, at 2c, Nsm_EventExposure_Notify (e.g., including the group ID, member list) (Early Notification) directly to the AF. Alternatively, SMF may use another or newly defined APIs for this purpose.

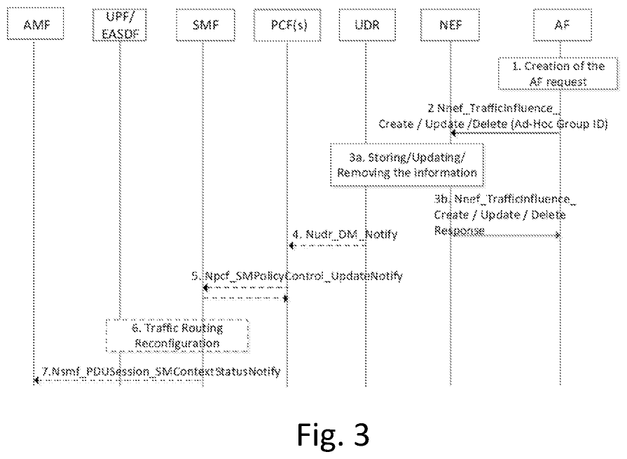

In the example of FIG. 2, at 4a, 4b and/or 4c, as part of late notification, the SMF may update the ad hoc group profile and any changes to the profile. For example, the SMF may send, at 4a, Nsmf_EventExposure_Notify (e.g., including group ID, member list) (Late Notification) or Nnef_TrafficInfluence_Notify (e.g., including group ID, member list) (Late Notification) if sent via NEF, or the SMF may send, at 4c, Nsmf_EventExposure_Notify (e.g., including group ID, member list) (Late Notification) directly to the AF. It should be noted that, in certain embodiments, some procedures illustrated in the example of FIG. 2 may correspond to procedures described elsewhere herein, such as in FIG. 1 or 3.

It is noted that FIG. 2 is provided as one example embodiment. However, certain embodiments are not limited to this example, and further examples are possible as discussed elsewhere herein.

FIG. 3 illustrates an example signaling diagram depicting an embodiment for AF subscription to receive notifications on an ad hoc group, according to one embodiment. The signaling diagram in the example of FIG. 2 depicts messages transmitted and received between an AMF, UPF/EASDF, SMF, PCF(s), UDR, NEF and an AF. An AF can be configured to request to influence traffic routing, and to subscribe to events related with PDU Sessions, using Nnef_TrafficInfluence_Create/Update message, where the AF may indicate the target by providing an individual UE, a group of UEs, or any UE. The example of FIG. 3 enables the AF to also subscribe to receive notifications related to ad hoc groups, such as receiving group information including the ad hoc group ID.

In the example of FIG. 3, at 1, the AF may create a request and, at 2, the AF may subscribe for notifications from the 5GC specific to an ad-hoc group indicated by an ad hoc group ID. In other words, the AF is thereby requesting the 5GC to provide any changes related to the group identified by the ad hoc group ID. As a result, the 5GC may provide to the AF any changes specific to the ad hoc group indicated in the request for subscription for notifications. It should be noted that, in certain embodiments, some procedures illustrated in the example of FIG. 3 may correspond to procedures described elsewhere herein, such as in FIG. 1 or 2.

Table 1 below illustrates some enhancements related to such dynamically managed ad-hoc group to an information element included in an AF request, according to certain embodiments.

TABLE 1

| | Applicable for PCF or | | |
|---|---|---|---|
| Information Name | NEF (NOTE 1) | Applicable for NEF only | Category |
| Traffic Description | Defines the target traffic | The target traffic can be | |
| | to be influenced, | represented by AF-Service- | |
| | represented by the | Identifier, instead of | |
| | combination of DNN and | combination of DNN and | |
| | optionally S-NSSAI, and | optionally S-NSSAI. | |
| | application identifier or | | |
| | traffic filtering | | |
| | information. | | |
| Potential Locations | Indicates potential | The potential locations of | Conditional |
| of Applications | locations of applications, | applications can be | (NOTE 2) |
| | represented by a list of | represented by AF-Service- | |
| | DNAI(s). | Identifier. | |
| Target UE | Indicates the UE(s) that | GPSI can be applied to | |
| Identifier(s) | the request is targeting, | identify the individual UE, | |
| | i.e. an individual UE, a | or External Group | |
| | group of UE represented | Identifier can be applied to | |
| | by Internal Group | identify a group of UE. | |
| | Identifier (NOTE 3), or | Ad hoc Group ID can be | |
| | any UE accessing the | applied to identified | |
| | combination of DNN, S- | group of UE belonging to | |
| | NSSAI and DNAI(s). | an ad-hoc group | |
| | Ad-Hoc group ID | | |
| Spatial Validity | Indicates that the request | The specified location can | Optional |
| Condition | applies only to the traffic | be represented by a list of | |
| | of UE(s) located in the | geographic zone | |
| | specified location, | identifier(s). | |
| | represented by areas of | | |
| | validity. | | |
| AF transaction | The AF transaction | N/A | |
| identifier | identifier refers to the AF | | |
| | request. | | |
| N6 Traffic Routing | Routing profile ID and/or | N/A | Optional |
| requirements | N6 traffic routing | | (NOTE 2) |
| | information | | |
| | corresponding to each | | |
| | DNAI and an optional | | |
| | indication of traffic | | |
| | correlation. | | |
| Application | Indicates whether an | N/A | Optional |
| Relocation | application can be | | |
| Possibility | relocated once a location | | |
| | of the application is | | |
| | selected by the 5GC. | | |
| UE IP address | Indicates UE IP address | N/A | Optional |
| preservation | should be preserved. | | |
| indication | | | |
| Temporal Validity | Time interval(s) or | N/A | Optional |
| Condition | duration(s). | | |
| Information on AF | Indicates whether the AF | N/A | Optional |
| subscription to | subscribes to change of | | |
| corresponding SMF | UP path of the PDU | | |
| events | Session and the | | |
| | parameters of this | | |
| | subscription. | | |
| | In case of Ad-Hoc group | | |
| | ID, this information | | |
| | indicates whether the | | |
| | AF subscribes to change | | |
| | specific to this ad hoc | | |
| | group e.g. updates on | | |
| | Ad Hoc group member | | |
| | list | | |
| Information for EAS | Indicates the Source EAS | N/A | Optional |
| IP Replacement in | identifier and Target EAS | | |
| 5GC | identifier, (i.e. IP | | |
| | addresses and port | | |
| | numbers of the source and | | |
| | target EAS). | | |
| User Plane Latency | Indicates the user plane | N/A | Optional |
| Requirement | latency requirements | | |
| Information on AF | N/A | Indicates the AF instance | Optional |
| change | | relocation and relocation | |
| | | information. | |
| Indication for EAS | Indicates the EAS | N/A | Optional |
| Relocation | relocation of the | | |
| | application(s) | | |
| Device Category | Type of application or use | Type of application or use | Optional |
| | case (e.g. CIoT, Public | case (e.g. CIoT, Public | |
| | Safety, V2X etc) | Safety, V2X etc) | |

(NOTE 1):
When the AF request targets existing or future PDU Sessions of multiple UE(s) or of any UE and is sent via the NEF, the information is stored in the UDR by the NEF and notified to the PCF by the UDR.
(NOTE 2):
The potential locations of applications and N6 traffic routing requirements may be absent only if the request is for subscription to notifications about UP path management events only.
(NOTE 3):
Internal Group ID can only be used by an AF controlled by the operator and only towards PCF.

It is noted that FIG. 3 is provided as one example embodiment. However, certain embodiments are not limited to this example, and further examples are possible as discussed elsewhere herein.

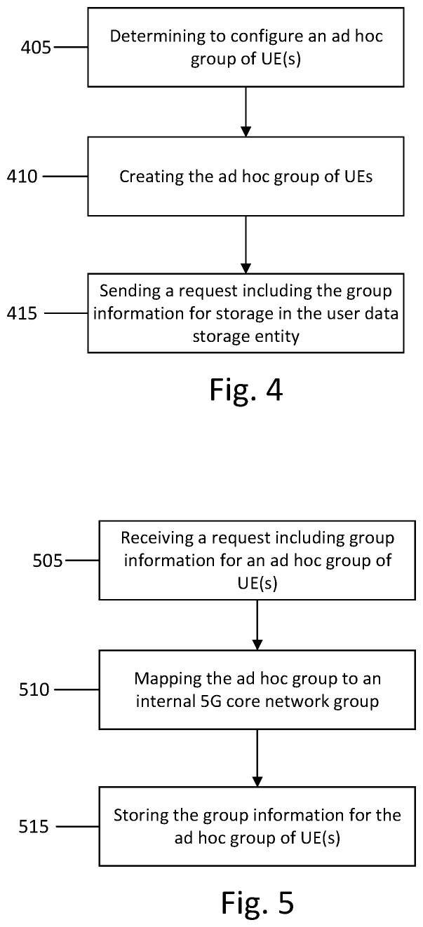

FIG. 4 illustrates an example flow diagram of a method for ad hoc group based services, according to one embodiment. In certain example embodiments, the flow diagram of FIG. 4 may be performed by a network entity or network node in a communications system, such as LTE or 5G NR. In some example embodiments, the network entity performing the method of FIG. 4 may include or be included in a base station, access node, node B, eNB, gNB, NG-RAN node, transmission-reception points (TRPs), high altitude platform stations (HAPS), relay station or the like. For example, according to certain embodiments, the entity performing the method of FIG. 4 may include a NF, AF, SMF, NEF, such as those illustrated in the examples of FIGS. 1-3, or any other entity discussed herein. The NF, AF, SMF, NEF or other entity performing the method of FIG. 4 may be capable of configuring an ad hoc group of UEs dynamically and of influencing ad hoc group creation within a 5GS.

As illustrated in the example of FIG. 4, the method may include, at 405, determining to configure an ad hoc group of UE(s) that may include dynamic group members. For instance, the ad hoc group of UE(s) may be a dynamically created group of UEs that may be used for a specific purpose, service and/or duration. Thus, the determining 405 may include determining to configure the ad hoc group of UEs for a specific use case or application, such as for time synchronization or time sensitive networks, multi-user gaming, and/or platooning. In an embodiment, the method may then include, at 410, creating the ad hoc group of UEs. According to certain embodiments, the creating 410 may include assigning group information for the ad hoc group, where the group information may include at least an external ad hoc group identifier (ID). According to some example embodiments, the creating 410 of the ad hoc group may be performed using the messaging sequence illustrated in the examples of FIGS. 1, 2 and/or 3 discussed above.

In some embodiments, the method may include, at 415, transmitting or sending, to a user data storage entity (e.g., a UDM/UDR), a request including the group information for storage in the user data storage entity. According to an embodiment, the group information may further include one or more of: a group type, a list of the member user equipment in the ad hoc group, property related with the group membership definition, an indication of one or more user equipment in a pre-defined or subscribed group that can be part of the ad hoc group, and/or a lifetime, time period or duration for the ad hoc group. According to certain embodiments, the property related with the group membership definition may include one or more of: a tracking area, cell identifier, location coordinates for the user equipment in the ad hoc group, an indication of user equipment having joined a certain multicast content, an indication of time synchronization service area for a given time domain serving area, an indication of the user equipment served by the same entity with a specific application running, and/or an indication of a user plane node serving the user equipment in the ad hoc group.

According to certain embodiments, the method may include dynamically updating or deleting the group information when a change to the ad hoc group occurs. For instance, a change to the ad hoc group that triggers such a dynamic update may include when a UE is removed from or added to the ad hoc group, or if the group is otherwise deleted or modified, such as if a certain UE is no longer registered on a particular application server, etc. As another example, the dynamically updating of the group information may include extending or otherwise modifying the lifetime, time period or duration of the ad hoc group. According to certain example embodiments, the updating may be carried out by means of the messages depicted in any of the examples of FIG. 1, 2 or 3.

In some embodiments, the method may include receiving, from a network node such as an application function, a request to subscribe to notifications specific to the ad hoc group, where the request identifies the ad hoc group by the ad hoc group identifier. For instance, the request may be a request to subscribe to receive notifications when a creation, modification or deletion occurs with respect to the ad hoc group.

It is noted that FIG. 4 is provided as one example embodiment of a method or process. However, certain embodiments are not limited to this example, and further examples are possible as discussed elsewhere herein.

FIG. 5 illustrates an example flow diagram of a method for ad hoc group based services, according to one embodiment. In certain example embodiments, the flow diagram of FIG. 5 may be performed by a network entity or network node in a communications system, such as LTE or 5G NR. In some example embodiments, the network entity performing the method of FIG. 5 may include or be included in a base station, access node, node B, eNB, gNB, NG-RAN node, transmission-reception points (TRPs), high altitude platform stations (HAPS), relay station or the like. For example, according to certain embodiments, the entity performing the method of FIG. 5 may include a user data management node, such as the UDM and/or UDR illustrated in the examples of FIGS. 1-3, or any other entity discussed herein.

As illustrated in the example of FIG. 5, the method may include, at 505, receiving a request including group information for an ad hoc group of UE(s). The received group information may include at least an external ad hoc group ID. According to an embodiment, the method may include, at 510, mapping the ad hoc group into an internal 5G core network group. For example, in some embodiments, the mapping 510 may be based on a user ID (e.g., GPSI), a UE ID (if provided), DNN, and/or S-NSSAI, etc. As further illustrated in the example of FIG. 5, the method may include, at 515, storing the group information for the ad hoc group of UE(s).

According to an embodiment, the group information may further include one or more of: a group type, a list of the member user equipment in the ad hoc group, property related with the group membership definition, an indication of one or more user equipment in a pre-defined or subscribed group that can be part of the ad hoc group, and/or a lifetime or duration for the ad hoc group. According to certain embodiments, the property related with the group membership definition may include one or more of: a tracking area, cell identifier, location coordinates for the user equipment in the ad hoc group, an indication of user equipment having joined a certain multicast content, an indication of time synchronization service area for a given time domain serving area, an indication of the user equipment served by the same entity with a specific application running, and/or an indication of a user plane node serving the user equipment in the ad hoc group.

In certain embodiments, the storing 515 may include storing the group type to differentiate between an ad hoc group of UEs and a static or permanent group of UEs. According to one embodiment, the storing 515 may include storing one or more of a sub-group type for the ad hoc group, and/or rules for determining membership in the ad hoc group.

According to some embodiments, the method may include receiving an update of the group information when a change to the ad hoc group occurs. For instance, the change to the ad hoc group may include when a UE is removed from or added to the ad hoc group, or if the group is otherwise deleted or modified, such as if a certain UE is no longer registered on a particular application server, etc.

In one embodiment, the method may also include receiving, from a consumer network node (e.g., PCF or SMF), a subscription to receive notifications for updates or changes to the ad hoc group, and notifying the subscribing consumer network node when such updates or changes occur in the ad hoc group. According to certain embodiments, the receiving of the subscription and the providing of the notifications may be performed via the example messages depicted in any of the example signaling diagrams of FIG. 1, 2, or 3.

It is noted that FIG. 5 is provided as one example embodiment of a method or process. However, certain embodiments are not limited to this example, and further examples are possible as discussed elsewhere herein.

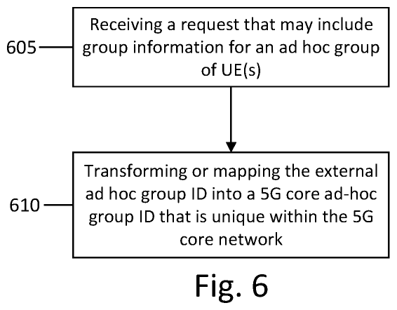

FIG. 6 illustrates an example flow diagram of a method for ad hoc group based services, according to one embodiment. In certain example embodiments, the flow diagram of FIG. 6 may be performed by a network entity or network node in a communications system, such as LTE or 5G NR. In some example embodiments, the network entity performing the method of FIG. 6 may include or be included in a base station, access node, node B, eNB, gNB, NG-RAN node, transmission-reception points (TRPs), high altitude platform stations (HAPS), relay station or the like. For example, according to certain embodiments, the entity performing the method of FIG. 6 may include a 5GC node, such as the SMF or PCF illustrated in the examples of FIGS. 1-3, or any other entity discussed herein.

As illustrated in the example of FIG. 6, the method may include, at 605, receiving a request that may include group information for an ad hoc group of UE(s). The group information may include at least an external ad hoc group ID. According to some embodiments, the group information may additionally include one or more of the information outlined in detail above. In an embodiment, the method may include, at 610, transforming or mapping the external ad hoc group ID into a 5G core ad-hoc group ID that is unique within the 5G core network.

It is noted that FIG. 6 is provided as one example embodiment of a method or process. However, certain embodiments are not limited to this example, and further examples are possible as discussed elsewhere herein.

It is further noted that, in certain embodiments, the methods depicted in FIG. 4, 5 or 6 may be combined in any appropriate manner

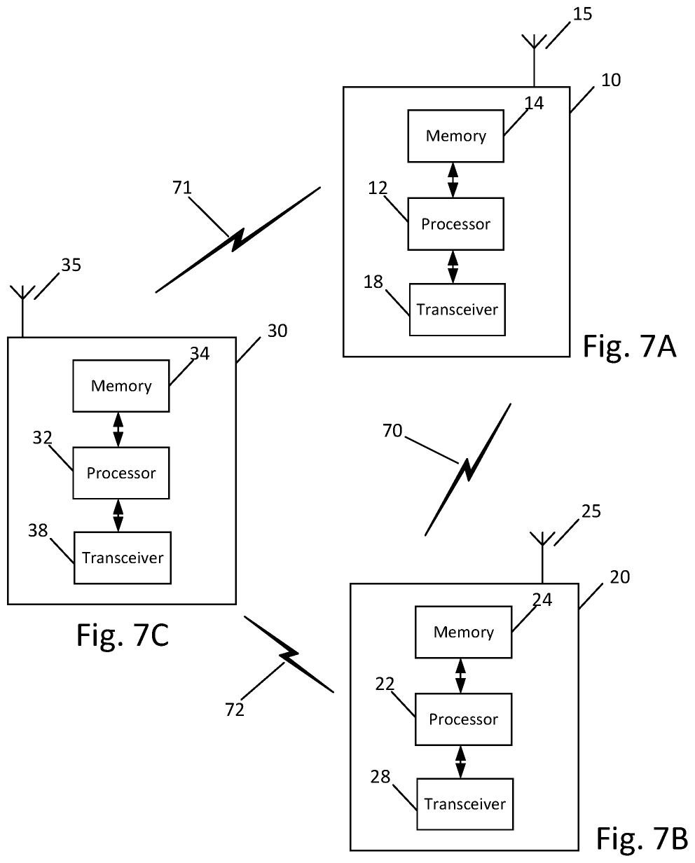

FIG. 7A illustrates an example of an apparatus 10 according to an embodiment. In an embodiment, apparatus 10 may be a node, host, or server in a communications network or serving such a network. For example, apparatus 10 may be a satellite, base station, a Node B, an evolved Node B (eNB), 5G Node B or access point, next generation Node B (NG-NB or gNB), transmission receive point (TRP), high altitude platform station (HAPS), integrated access and backhaul (IAB) node, and/or WLAN access point, associated with a radio access network, such as a LTE network, 5G or NR. In one example embodiment, apparatus 10 may represent a NF, AF, SMF, or other 5GC node, such as those illustrated in FIGS. 1-3.

It should be understood that, in some example embodiments, apparatus 10 may be comprised of an edge cloud server as a distributed computing system where the server and the radio node may be stand-alone apparatuses communicating with each other via a radio path or via a wired connection, or where they may be located in a same entity communicating via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 7A.

As illustrated in the example of FIG. 7A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples.

While a single processor 12 is shown in FIG. 7A, multiple processors may be utilized according to other example embodiments. For example, it should be understood that, in certain embodiments, apparatus 10 may include two or more processors that may form a multiprocessor system (e.g., in this case processor 12 may represent a multiprocessor) that may support multiprocessing. In some embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and/or receive information. The transceiver 18 may include, for example, a plurality of radio interfaces that may be coupled to the antenna(s) 15, or may include any other appropriate transceiving means. In certain embodiments, the radio interfaces may correspond to a plurality of radio access technologies including one or more of GSM, NB-IoT, LTE, 5G, WLAN, Bluetooth, BT-LE, NFC, radio frequency identifier (RFID), ultrawideband (UWB), MulteFire, and/or the like. According to an example embodiment, the radio interface may include components, such as filters, converters (e.g., digital-to-analog converters and the like), mappers, a Fast Fourier Transform (FFT) module, and/or the like, e.g., to generate symbols or signals for transmission via one or more downlinks and to receive symbols (e.g., via an uplink).

As such, transceiver 18 may be configured to modulate information on to a carrier waveform for transmission by the antenna(s) 15 and to demodulate information received via the antenna(s) 15 for further processing by other elements of apparatus 10. In other example embodiments, transceiver 18 may be capable of transmitting and receiving signals or data directly. Additionally or alternatively, in some embodiments, apparatus 10 may include an input device and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry or control circuitry. In addition, in some embodiments, transceiver 18 may be included in or may form a part of transceiver circuitry.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be a network node or RAN node, such as a base station, access point, Node B, eNB, gNB, TRP, HAPS, IAB node, WLAN access point, or the like. In one example embodiment, apparatus 10 may be a NF, AF, SMF, or other 5GC node. For example, in some embodiments, apparatus 10 may be configured to perform one or more of the processes depicted in any of the flow charts or signaling diagrams described herein, such as those illustrated in any of FIGS. 1-6. In some embodiments, as discussed herein, apparatus 10 may be configured to perform a procedure relating to the creation, update, and management of dynamic ad hoc UE groups, for example.

FIG. 7B illustrates an example of an apparatus 20 according to another embodiment. In an embodiment, apparatus 20 may be a node or element in a communications network or associated with such a network, such as a satellite, base station, a Node B, an evolved Node B (eNB), 5G Node B or access point, next generation Node B (NG-NB or gNB), transmission receive point (TRP), high altitude platform station (HAPS), integrated access and backhaul (IAB) node, and/or WLAN access point, associated with a radio access network, such as a LTE network, 5G or NR. In one example embodiment, apparatus 10 may represent a data storage or repository including a user subscription data storage, such as the UDM and/or UDR illustrated in FIGS. 1-3.

It should be understood that, in some example embodiments, apparatus 20 may be comprised of an edge cloud server as a distributed computing system where the server and the radio node may be stand-alone apparatuses communicating with each other via a radio path or via a wired connection, or they may be located in a same entity communicating via a wired connection. For instance, in certain example embodiments where apparatus 20 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 20 may include components or features not shown in FIG. 7B.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 7B.

As illustrated in the example of FIG. 7B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 7B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 or apparatus 30 via a wireless or wired communications link or interface 70 according to any radio access technology, such as NR.

According to some embodiments, processor 22 and memory 24 may be included in or may form a part of processing circuitry/means or control circuitry/means. In addition, in some embodiments, transceiver 28 may be included in or may form a part of transceiving circuitry or transceiving means.

As discussed above, according to some embodiments, apparatus 20 may be a data storage or repository including a user subscription data storage, such as the UDM and/or UDR, for example. According to certain embodiments, apparatus 20 may be controlled by memory 24 and processor 22 to perform the functions associated with example embodiments described herein. For example, in some embodiments, apparatus 20 may be configured to perform one or more of the processes depicted in any of the flow charts or signaling diagrams described herein, such as those illustrated in FIGS. 1-6. Thus, according to an embodiment, apparatus 20 may be configured to perform a procedure relating to the creation, management and/or update of dynamic ad hoc UE groups as discussed elsewhere herein, for instance.

FIG. 7C illustrates an example of an apparatus 30 according to another example embodiment. In an example embodiment, apparatus 30 may be a node or element in a communications network or associated with such a network, such as a satellite, base station, a Node B, an evolved Node B (eNB), 5G Node B or access point, next generation Node B (NG-NB or gNB), and/or WLAN access point, associated with a radio access network, such as a LTE network, 5G or NR. According to one embodiment, apparatus 30 may be or may be included in a 5GC node, such as a PCF, SMF or NEF, for example.

In some example embodiments, apparatus 30 may include one or more processors, one or more computer-readable storage medium (for example, memory, storage, or the like), one or more radio access components (for example, a modem, a transceiver, or the like), and/or a user interface. In some example embodiments, apparatus 30 may be configured to operate using one or more radio access technologies, such as GSM, LTE, LTE-A, NR, 5G, WLAN, WiFi, NB-IoT, MulteFire, and/or any other radio access technologies. It should be noted that one of ordinary skill in the art would understand that apparatus 30 may include components or features not shown in FIG. 7C.

As illustrated in the example of FIG. 7C, apparatus 30 may include or be coupled to a processor 32 for processing information and executing instructions or operations. Processor 32 may be any type of general or specific purpose processor. In fact, processor 32 may include one or more of general- purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 32 is shown in FIG. 7C, multiple processors may be utilized according to other example embodiments. For example, it should be understood that, in certain example embodiments, apparatus 30 may include two or more processors that may form a multiprocessor system (e.g., in this case processor 32 may represent a multiprocessor) that may support multiprocessing. In certain example embodiments, the multiprocessor system may be tightly coupled or loosely coupled (e.g., to form a computer cluster).

Processor 32 may perform functions associated with the operation of apparatus 30 including, as some examples, precoding of antenna gain/phase parameters, encoding and decoding of individual bits forming a communication message, formatting of information, and overall control of the apparatus 30, including processes related to management of communication resources.

Apparatus 30 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 34 can be comprised of any combination of random access memory (RAM), read only memory (ROM), static storage such as a magnetic or optical disk, hard disk drive (HDD), or any other type of non-transitory machine or computer readable media. The instructions stored in memory 34 may include program instructions or computer program code that, when executed by processor 32, enable the apparatus 30 to perform tasks as described herein.

In an example embodiment, apparatus 30 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 32 and/or apparatus 30.

In some example embodiments, apparatus 30 may also include or be coupled to one or more antennas 35 for receiving a downlink signal and for transmitting via an uplink from apparatus 30. Apparatus 30 may further include a transceiver 38 configured to transmit and receive information. The transceiver 38 may also include a radio interface (e.g., a modem) coupled to the antenna 35. The radio interface may correspond to a plurality of radio access technologies including one or more of GSM, LTE, LTE-A, 5G, NR, WLAN, NB-IoT, BT-LE, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 38 may be configured to modulate information on to a carrier waveform for transmission by the antenna(s) 35 and demodulate information received via the antenna(s) 35 for further processing by other elements of apparatus 30. In other example embodiments, transceiver 38 may be capable of transmitting and receiving signals or data directly. Additionally or alternatively, in some example embodiments, apparatus 30 may include an input and/or output device (I/O device). In certain example embodiments, apparatus 30 may further include a user interface, such as a graphical user interface or touchscreen.

In an example embodiment, memory 34 stores software modules that provide functionality when executed by processor 32. The modules may include, for example, an operating system that provides operating system functionality for apparatus 30. The memory may also store one or more functional modules, such as an application or program, to provide additional functionality for apparatus 30. The components of apparatus 30 may be implemented in hardware, or as any suitable combination of hardware and software. According to an example embodiment, apparatus 30 may optionally be configured to communicate with apparatus 10 via a wireless or wired communications link 71 and/or to communicate with apparatus 20 via a wireless or wired communications link 72, according to any radio access technology, such as NR.

According to some example embodiments, processor 32 and memory 34 may be included in or may form a part of processing circuitry or control circuitry. In addition, in some example embodiments, transceiver 38 may be included in or may form a part of transceiving circuitry.

As discussed above, according to some example embodiments, apparatus 30 may be a 5GC node, for example. According to certain example embodiments, apparatus 30 may be controlled by memory 34 and processor 32 to perform the functions associated with example embodiments described herein. For instance, in some example embodiments, apparatus 30 may be configured to perform one or more of the processes depicted in any of the diagrams or signaling flow diagrams described herein, such as those illustrated in FIGS. 1-6. According to certain example embodiments, apparatus 30 may be configured to perform a procedure relating to the creation, management and/or update of dynamic ad hoc UE groups, for instance.

In some embodiments, an apparatus (e.g., apparatus 10 and/or apparatus 20 and/or apparatus 30) may include means for performing a method, a process, or any of the variants discussed herein. Examples of the means may include one or more processors, memory, controllers, transmitters, receivers, and/or computer program code for causing the performance of the operations.

In view of the foregoing, certain example embodiments provide several technological improvements, enhancements, and/or advantages over existing technological processes and constitute an improvement at least to the technological field of wireless network control and management. For example, certain embodiments are configured to allow a network node, such as an AF or 5GC node, to form and/or dynamically update an ad-hoc or dynamic UE group based on criteria such as the UEs being anchored at the same PSA-UPF and/or the UEs running applications on the same EAS (e.g., registered with respective application user ID to same EAS for a particular application ID). In addition, example embodiments, can enable UEs that belong to the same ad-hoc/dynamic group to be relocated simultaneously to another EAS, for example. Further example embodiments can enable one, more or all UEs on one PSA-UPF to be relocated to another PSA-UPF, if they belong to the same Ad-Hoc group. Additionally, some embodiments can be configured to create a time synchronization group and ensure that the group members are served by the same PTP instance. Accordingly, the use of certain example embodiments results in improved functioning of communications networks and their nodes, such as base stations, eNBs, gNBs, 5GC nodes, and/or IoT devices, UEs or mobile stations.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations required for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

We claim:

1. A method, comprising:
determining, by a network node, to dynamically configure an ad hoc group of user equipment within a 5G system, the ad hoc group of user equipment comprising dynamic group members; and
creating the ad hoc group of user equipment, wherein the creating comprises assigning group information for the ad hoc group, and wherein the group information comprises at least an external ad hoc group identifier.

2. The method of claim 1, further comprising:
sending, to a user data storage entity, a request comprising the group information for storage in the Unified Data Repository storage entity.

3. The method of claim 1, wherein the group information further comprises at least one of:
a group type;
a list of the member user equipment in the ad hoc group;
property or an application or use case related with the group membership definition;
an indication of one or more user equipment in a pre-defined or subscribed group that can be part of the ad hoc group; or
a lifetime, time period or duration for the ad hoc group.

4. The method of claim 3, wherein the property related with the group membership definition comprises at least one of:
a tracking area, cell identifier, location coordinates for the user equipment in the ad hoc group;
an indication of user equipment having joined a certain multicast content;
an indication of time synchronization service area for a given time domain serving area;
an indication of the user equipment served by the same entity with a specific application running;
an indication of a user plane node serving the user equipment in the ad hoc group; or
an indication of device, application or use case category for the user equipment to be present in the ad-hoc group.

5. The method of claim 1, wherein the determining comprises determining to configure the ad hoc group of user equipment for a specific use case or application.

6. The method of claim 1, further comprising:
dynamically updating or deleting the group information when a change to the ad hoc group occurs.

7. The method of claim 1, further comprising:
receiving, from an application function, a request to subscribe to notifications specific to the ad hoc group, wherein the request identifies the ad hoc group by the ad hoc group identifier.

8. The method of claim 1, wherein the network node comprises at least one of:
a network function; or a 5G core network node.

9. A method, comprising:
receiving, at a unified data management entity or unified data repository, a request comprising group information for an ad hoc group of user equipment, wherein the group information comprises at least an external ad hoc group identifier; and
storing the group information for the ad hoc group of user equipment.

10. The method of claim 9, wherein the group information further comprises at least one of:
a group type;
a list of the member user equipment in the ad hoc group;
property related with the group membership definition;
an indication of one or more user equipment in a pre-defined or subscribed group that can be part of the ad hoc group; or
a lifetime, time period or duration for the ad hoc group.

11. The method of claim 9, wherein the storing comprises storing at least one of the group type or a sub-group type to differentiate between an ad hoc group of user equipment and a static or permanent group of user equipment.

12. The method of claim 9, further comprising:
mapping the ad hoc group into an internal 5G System group.

13. The method of claim 9, wherein the property related with the group membership definition comprises at least one of:
a tracking area, cell identifier, location coordinates for the user equipment in the ad hoc group
an indication of user equipment having joined a certain multicast content
an indication of time synchronization service area for a given time domain serving area;
an indication of the user equipment served by the same entity with a specific application running; or
an indication of a user plane node serving the user equipment in the ad hoc group.

14. The method of claim 9, wherein the storing comprises storing at least one of:
a sub-group type for the ad hoc group; or
rules for membership to the ad hoc group.

15. The method of claim 9, further comprising:
receiving an update of the group information when a change to the ad hoc group occurs.

16. The method of claim 9, further comprising:
receiving, from a consumer network node, a subscription to receive notifications for updates or changes to the ad hoc group; and
notifying the subscribing consumer network node when the updates or changes occur in the ad hoc group.

17. A method, comprising:
receiving, at a 5G core network node, a request comprising group information for an ad hoc group of user equipment, wherein the group information comprises at least an external ad hoc group identifier; and
transforming the external ad hoc group identifier into a 5G core ad-hoc group identifier that is unique within the 5G System.

18. An apparatus, comprising:
at least one processor; and
at least one memory including computer program code,
the at least one memory and computer program code configured, with the at least one processor, to cause the apparatus at least to perform a method according to claim 1.

19. An apparatus, comprising:
at least one processor; and
at least one memory including computer program code,
the at least one memory and computer program code configured, with the at least one processor, to cause the apparatus at least to perform a method according to claim 9.

20. A non-transitory computer readable medium including program instructions stored thereon which, when executed on a processor, cause the processor to perform at least the method according to claim 1.

21. A non-transitory computer readable medium including program instructions stored thereon which, when executed on a processor, cause the processor to perform at least the method according to claim 9.
